(19) United States
(12) Patent Application Publication
(10) Pub. No.: US 2026/0250918 A1
(43) Pub. Date: Aug. 27, 2026

(54) ACTIVE STUD CONFIGURED TO PROVIDE OMNIDIRECTIONAL LIGHT OUTPUT

(71) Applicant: CLEARVIEW INTELLIGENCE LTD., Milton Keynes, Buckinghamshire (GB)

(72) Inventor: Alastair KING, Northampton, Nottinghamshire (GB)

(73) Assignee: CLEARVIEW INTELLIGENCE LTD., Milton Keynes, Buckinghamshire (GB)

(21) Appl. No.: 18/995,429

(22) PCT Filed: Aug. 15, 2022
(86) PCT No.: PCT/IB2022/057620

§ 371 Date: Jan. 16, 2025

(51) Int. Cl. E01F 9/559; F21S 8/00; F21S 9/03; F21V 7/04

(52) U.S. Cl. CPC E01F 9/559; F21S 8/032; F21S 9/037; F21V 7/04

(57) ABSTRACT

An active stud is installable in-ground for use in applications including pedestrian or cyclist pathways and airport environments. The active stud includes a single light-emitting diode (LED), a domed mirror, and a housing. The domed mirror is positioned above the LED in optical communication with the LED. The housing has a top side that forms a domed outer shell. The LED and the domed mirror are housed in the housing. The domed mirror reflects light from the LED out in an omnidirectional ring around the domed outer shell of the housing while blocking light from the LED from being emitted directly through the top side of the housing.

### TECHNICAL FIELD

The present invention relates to active studs installed in-ground for delineating a path.

### BACKGROUND

Studs are installed in-ground for numerous purposes, such as for to delineate a path. For instance, road studs (e.g., pavement markers) are installed in roadways to mark lanes and edges of the roadway. Such studs are similarly installed for runways, holding areas, and taxiways in an airport environment. An active stud emits visible light for persons in the vicinity to see. For instance, active road studs, compliant with the standard BS EN 1463.3, emit visible light for roadway users including vehicle users to see, as opposed to reflecting light back to the roadway users.

With increasing governmental promotion and incentivizing of active travel such as walking and cycling as modes of transport, there is an ongoing push by local councils/agencies to expand their active travel networks and/or upgrade existing sites. In most instances of councils/agencies publishing their commitment to improving active travel throughout their networks, a trend is a desire of building new key active travel routes or re-designing existing road layouts to prioritize combined pedestrian/cycle lanes. Large-scale industry changes to physical infrastructure or a completely new design of mobility schemes provides an opportunity to specify delineation products from the outset.

Further, authorities are becoming much more conscious of emitted light (e.g., light-emitting diode (LED) light) delineation from active studs and its impact on local wildlife such as bats and insects. For example, trails of light caused by installation of delineation on pathways by conventional active studs can confuse bats as they follow the lights rather than their programmed flight paths to essential locations such as hunting grounds or nests. Additionally, there is demand for sustainable long-term solutions, i.e., essentially renewable energy such as solar power.

### SUMMARY

Embodiments of the present invention provide an active stud that (i) emits an omnidirectional (or a 360°) source of active light, (ii) is fully sustainable (i.e., solar powered), (iii) is designed for use in pedestrian footpaths or cycle ways, and (iv) minimizes light exposure in an upward trajectory, such as by ensuring that light is not emitted directly above the active stud, to thereby minimize impact of use of the active stud on wildlife.

In some embodiments, the active stud exports relatively large amounts of light through one light-emitting diode (LED) and a reflective ‘light tunnel’ inside the active stud. This maximizes performance of delineation through a single LED whilst maximizing efficiencies from internal components of the active stud by expanding output quality from a single solar panel, battery, and the LED of the active stud.

In an embodiment, an active stud includes a single LED, a domed mirror positioned above the LED in optical communication with the LED, and a housing having a top side that forms a domed outer shell. The LED and the domed mirror are housed within the housing. The domed mirror reflects light from the LED out in an omnidirectional ring around the domed outer shell of the housing while blocking light from the LED from being emitted directly through the top side of the housing.

The domed outer shell of the housing may have a tinted surface. In this case, the domed mirror reflects the light from the LED out in the omnidirectional ring around the tinted surface of the domed outer shell of the housing. Further in this case, the tinted surface of the domed outer shell of the housing may have grips.

The domed mirror may be of plastic.

The active stud may further include a solar panel housed within the housing for converting solar energy into electricity. In this case, the domed mirror may be positioned underneath the solar panel. Further in this case, the active stud may further include a battery housed within the housing for supplying electricity to the LED. The battery is configured to store electricity from the solar panel.

The active stud may further include a printed circuit board (PCB) housed within the housing. The LED may be positioned on the PCB.

The active stud may be installable in-ground for use in a pedestrian or cyclist pathway or in an airport environment.

### BRIEF DESCRIPTION OF THE DRAWINGS

FIG. 1A illustrates a perspective view of an active stud in accordance with embodiments of the present invention;

FIG. 1B illustrates a first side view of the active stud;

FIG. 1C illustrates a second side view of the active road rotated by 90° with respect to the first side view;

FIG. 1D illustrates a third side view of the active road rotated by 180° with respect to the first side view; and

FIG. 1E a top view of the active road.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

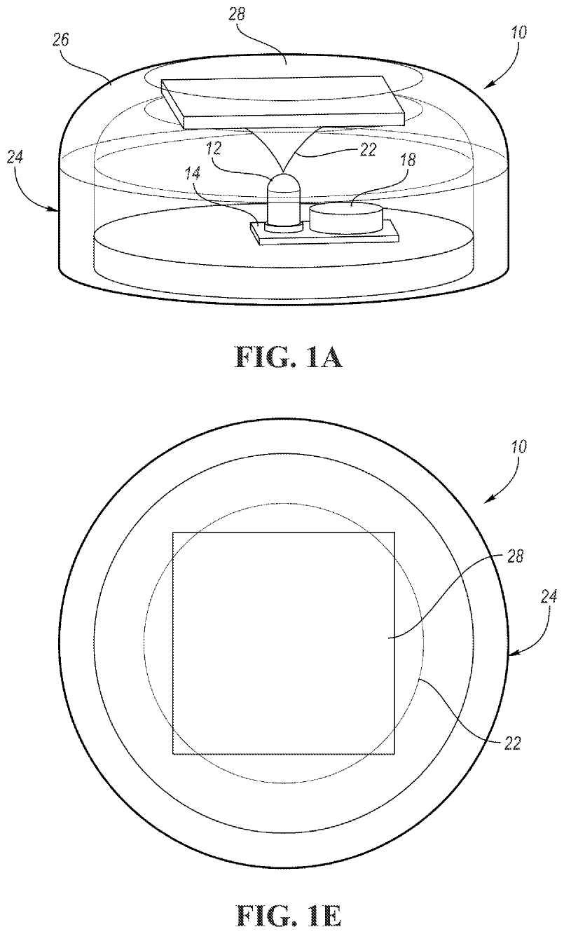

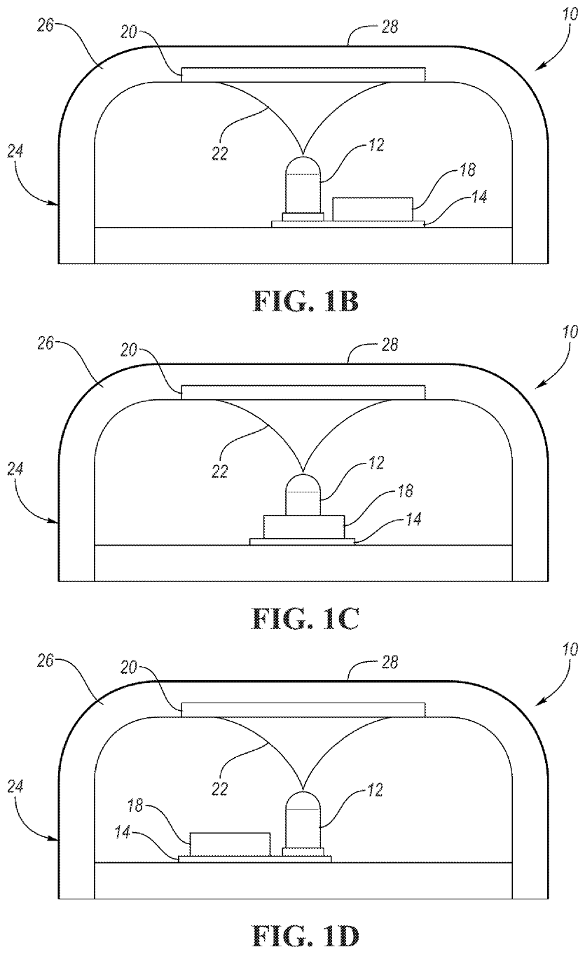

Referring now to FIG. 1, a schematic diagram of an active stud 10 in accordance with embodiments of the present invention is shown. Active stud 10 includes a light-emitting diode (LED) 12, a printed circuit board (PCB) 14, a battery 18, a solar panel 20, and a domed (360°) mirror 22. Active stud 10 further includes a housing 24 in which LED 12, PCB 14, batteries 18, solar panel 20, and domed mirror 22 are housed. Housing 24 is preferably a clear enclosure. A top side of housing 24 forms a domed outer shell 26. A top surface of domed outer shell 26 preferably is a tinted surface 28 having grips.

LED 12 is positioned in a center or proximate a central region of PCB 14. LED 12 emits light upward and emits light immediately downward through a reflective tunnel sidewall.

Domed mirror 22, which preferably is made of plastic or another translucent material, sits opposite LED 12. Particularly, domed mirror 22 sits opposite LED 12, either underneath solar panel 20 (as shown in FIG. 1) or at the base of active stud 10. Domed mirror 22 is designed to maximize full 360° visibility optimized for pedestrians and cyclists. As such, domed mirror 22 is a 360° domed mirror. In this regard, domed mirror 22 reflects light from LED 12 out in a 360° ring around tinted top surface 28 of domed outer shell 26 of housing 24. That is, light from LED 12 reflects off domed mirror 22 into domed outer shell 26, thereby creating a “360° ring” effect.

Battery 18 provides electrical power to operate LED 12. Solar panel 20 converts solar light into electricity to charge battery 18 throughout the day. Accordingly, active stud 10 provides a sustainable form of delineation.

In some embodiments, active stud 10 includes features to optimize installation for a given specific application. Such features include, for example, thirty mm product depth, 120 mm product width, no requirement or need for any form of retro-reflectivity, and/or fully potted internal components.

Active stud 10 maximizes efficiencies through use of single components (e.g., single LED 12) and a reflective light tunnel for (if desired) a full 360° light output. The reflective light tunnel is configured to carry light output in such a way that a 360° light output is optimized.

Features of active stud 10 include a full 360° light output visibility from one single LED using a light tunnel, the light output is optimized for pedestrian and cyclists, and an optimized flush stud design with a grippy top surface to ensure pedestrian and cyclist compatibility.

As described, use of the internal 360° domed mirror circular to the shape of active stud 10 enables the design and performance of the LED and light tunnel.

Active stud 10 provides a pedestrian/cyclist friendly source of active stud delineation that uses sustainable energy in a way that ensures longevity of product life, ensures compatibility and friendliness toward local wildlife, maximizes product components, uses a specialized light tunnel for maximum 360° LED coverage, and maintains areas of natural beauty without excessive light output upward.

As set forth, active stud 10 provides a pedestrian/cycle route application.

In use, a plurality of active studs 10 are installed along a path for use in active travel. In some embodiments, to make the active travel proposition ‘smarter’, the plurality of active studs 10 are configured to provide a chasing LED solution. The chasing LED solution would follow pathway users as they make their trip along a route in the hours of darkness. This would require an above ground form of detection which communicates with each active stud 10. In this case, active studs 10 may further be configured to reserve solar energy directly for when it is required. Such enhancements may act as an entry point for additional smart stud technology proposals such as temperature measurements and pedestrian/cycle route count.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. An active stud comprising:
a single light-emitting diode (LED);
a domed mirror positioned above the LED in optical communication with the LED;
a housing having a top side that forms a domed outer shell;
wherein the LED and the domed mirror are housed within the housing; and
the domed mirror reflects light from the LED out in an omnidirectional ring around the domed outer shell of the housing while blocking light from the LED from being emitted directly through the top side of the housing.

2. The active stud of claim 1 wherein:
the domed outer shell of the housing has a tinted surface; and
the domed mirror reflects the light from the LED out in the omnidirectional ring around the tinted surface of the domed outer shell of the housing.

3. The active stud of claim 2 wherein:
the tinted surface of the domed outer shell of the housing has grips.

4. The active stud of claim 1 wherein:
the domed mirror is plastic.

5. The active stud of claim 1 further comprising:
a solar panel housed within the housing for converting solar energy into electricity.

6. The active stud of claim 5 wherein:
the domed mirror is positioned underneath the solar panel.

7. The active stud of claim 5 further comprising:
a battery housed within the housing for supplying electricity to the LED; and
wherein the battery is configured to store electricity from the solar panel.

8. The active stud of claim 1 further comprising:
a printed circuit board (PCB) housed within the housing; and
wherein the LED is positioned on the PCB.

9. The active stud of claim 1 wherein:
the active stud is installable in-ground for use in a pedestrian or cyclist pathway.

10. The active stud of claim 1 wherein:
the active stud is installable in-ground for use in an airport environment.
